(19) United States
(12) Patent Application Publication
(10) Pub. No.: US 2025/0245408 A1
(43) Pub. Date: Jul. 31, 2025

(54) METHOD FOR 3D RECONSTRUCTION OF SOLDER JOINT ON PCB UTILIZING NEURAL RENDERING

(71) Applicant: University of Electronic Science and Technology of China, Chengdu (CN)

(72) Inventors: Yali ZHENG, Chengdu (CN); Zhiming CHEN, Chengdu (CN); Hang HUA, Chengdu (CN); Yaoyu DING, Chengdu (CN); Libing BAI, Chengdu (CN)

(21) Appl. No.: 18/793,913

(22) Filed: Aug. 4, 2024

(30) Foreign Application Priority Data
Jan. 30, 2024 (CN) 202410128665.4

(51) Int. Cl. G06F 30/32; G06F 115/12; H05K 1/11

(52) U.S. Cl. CPC G06F 30/32; H05K 1/111; G06F 2115/12; H05K 2201/10734

(57) ABSTRACT

A 3D reconstruction method for PCB solder joints based on neural rendering, including using the signed distance function (SDF) to represent the solder joint surface, combining the bidirectional reflectance distribution function (BRDF) with the calibrated incident angle to represent the light intensity of solder joint images, and then unifying them into the neural rendering framework to optimize. The method uses existing solder joint inspection equipment to collect solder joint image, and reconstructs high resolution 3D reconstruction of solder joint from a single image with low cost.

### CROSS-REFERENCE TO RELATED APPLICATIONS

Pursuant to 35 U.S.C. § 119 and the Paris Convention Treaty, this application claims foreign priority to Chinese Patent Application No. 202410128665.4 filed Jan. 30, 2024, the contents of which, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, MA 02142.

### BACKGROUND

The disclosure relates to the field of 3D reconstruction in computer vision and defect detection in Printed Circuit Board Surface Mounted Technology (PCB SMT), and more particularly, to a method of 3D reconstruction of a solder joint on a printed circuit board (PCB). The method is utilized for the detection of defects in the solder joint.

During the production process of a PCB, electronic components are placed on a pad with solder paste and connected to the pads through a reflow oven or high-temperature soldering iron to form solder joints. The quality of the solder joints determines the quality of signal conduction. Common defects in solder joint include missing solder, insufficient solder, and excessive solder. The current PCB production process requires the use of automated optical inspection (AOI) equipment to detect defects in solder joints. 3D solder joint AOI equipment mainly relies on high-precision laser sensors to achieve 3D imaging of solder joints, with the accuracy of the laser sensors correlating to higher costs. Conversely, 2D solder joint AOI equipment mainly uses three-color ring light sources and small-angle viewed cameras to collect images. The three-color ring light sources include red, green, and blue light sources positioned at different angles. The image of the solder joint under inspection is compared with a reference image to determine if the solder joint is acceptable. While the 2D image-based detection method is cost-effective but depends on the experience of inspectors.

### SUMMARY

The purpose of the disclosure is to achieve high-precision 3D reconstruction of solder joints using 2D solder joint images captured by widespread 2D AOI equipment without any increasing hardware costs. The disclosure uses the SDF to represent the solder joint surface, combines the BRDF with the calibrated incident angle to represent the light intensity of solder joint images, and then unifies them into the neural rendering framework to optimize. The proposed method uses existing widespread solder joint inspection equipment collects solder joint image, and reconstruct high resolution 3D reconstruction of solder joint from a single image with low cost.

A method for 3D reconstruction of a solder joint on a printed circuit board (PCB) utilizing neural rendering, and the method comprises:
Step 1: soldering a plurality of steel balls of different known diameters onto a blank PCB; providing an acquisition system comprising a red ring light source, a green ring light source, and a blue ring light source; adjusting an angle between each ring light source and an vertical axis to be between 10° and 70°; adjusting an intensity of each ring light source; collecting, using the acquisition system, a plurality of images of the plurality of steel balls; and calibrating an angle θ=[θ^{r},θ^{g},θ^{b}] between an incident light ray from each ring light source and a viewing direction v; performing multiple calibrations using the plurality of steel balls of different known diameters to determine an average angle;
Step 2: capturing, using the acquisition system, a PCB image; extracting an image patch Iₚ corresponding to a location of a solder joint in the PCB image; wherein a width of the image patch is assumed to be W and a height of the image patch is H, then IₚϵR^{W×H};
Step 3: establishing a camera coordinate system with a camera center P as an origin; and defining the viewing direction \vec{v} along the negative direction of the z-axis of the camera coordinate system; sampling a light ray passing through each pixel in the image patch along the direction of the z-axis; sampling a plurality of spatial points \tilde{x} along the light ray passing through the camera center P; transforming the plurality of spatial points \tilde{x} into a normalized coordinates system; denoting the plurality of transformed spatial points as x; and encoding the coordinates of the plurality of transformed spatial points x as E(x); where, the number of the plurality of spatial points is m, the coordinates of the plurality of spatial points are denoted by \tilde{x}ϵR^{W×H×m}; and E(x) is calculated as follows:

E(x)=[x,sin (x), cos (x), sin (2x), cos (2x), . . . , sin (6x), cos (6x)]

Step 4: establishing a Signed Distance Field (SDF) multi-layer perceptron (MLP) network N₁; inputting E(x) into the SDF MLP network to obtain a signed distance d from each of the plurality of spatial points to a surface of the solder joint; supposing F(x) represent the SDF; and defining an opacity function as follows:

σ(x)=ϕ(F(E(x)))ϵ[0,1];

where,

$$ϕ ( F ( x ) ) = s \cdot \frac{{e}^{- s \cdot F ( x )}}{( 1 + {e}^{- s \cdot {F ( x )}^{2}} )}$$

and; an analytical partial derivative where,

$$\frac{\partial F ( x )}{\partial x}$$

of the SDF MLP network is calculated to obtain the normal \vec{n} of the plurality of transformed spatial points x; and s is a learnable parameter;

Step 5: defining a mixed reflection model of light intensity as follows:

$$c = {W}_{d} \cdot {B}_{d} + {W}_{s} \cdot {B}_{s}$$

computing two sets of spherical Gaussians for a specular component and a diffuse component, respectively;

$${B}_{s} = [ {e}^{{λ}_{1} ( {\vec{h}}^{T} \vec{n} - 1 )} , {e}^{{λ}_{2} ( {\vec{h}}^{T} \vec{n} - 1 )} , … , {e}^{{λ}_{10} ( {\vec{h}}^{T} \vec{n} - 1 )} ] ,$$

$${B}_{d} = [ {e}^{{λ}_{1} ( {\vec{i}}^{T} \vec{n} - 1 )} , {e}^{{λ}_{2} ( {\vec{i}}^{T} \vec{n} - 1 )} , … , {e}^{{λ}_{10} ( {\vec{i}}^{T} \vec{n} - 1 )} ] ,$$

where Bₛ represents a spherical Gaussian basis for the specular component, B_{d} represents a spherical Gaussian basis for the diffuse component, λ₁, λ₂, . . . , λ₁₀ represent preset parameters of the spherical Gaussians basis. \vec{h}, \vec{n}, ī represent an intermediate vector, a normal direction, and an incident light ray direction, respectively; where \vec{h}=\vec{v}+\vec{i}; and the incident light ray direction is denoted as follows:

i=(sin θᵢ cos φᵢ, sin θᵢ sin φᵢ, cos θᵢ)
where θᵢ is a calibrated angle between the incident light ray and the viewing direction;

$${φ}_{i} = arctan \frac{{\vec{n}}_{y}}{{\vec{n}}_{x}} ;$$

\vec{n}ₓ and \vec{n}_{y} are components of the normal \vec{n} on the x-axis and y-axis, respectively;
Step 6: constructing two Bidirectional Reflectance Distribution Function (BRDF) Multi-Layer Perceptron (MLP) networks N₂ and N₃ with identical network structure; inputting x into the two MLP networks N₂ and N₃; generating an output from each MLP network; wherein the output from BRDF MLP network N₂ is a weight W_{d} corresponding to a 10-dimensional spherical Gaussians, and the output from BRDF MLP network N₃ is a weight Wₛ corresponding to a 10-dimensional spherical Gaussians;

$$c ( x ) = {W}_{d} \cdot {B}_{d} + {W}_{s} \cdot {B}_{s}$$

the components of light intensity emitted by the red ring light source, the green ring light source, the blue ring light source at the plurality of transformed spatial points x are represented by c^{r}, c^{g}, c^{b}, respectively;
Step 7: rendering an image through σₖ, δₖ, cₖ by the rendering formula as follows:

$${T}_{k} = {e}^{- {{Σ}_{j = 1}}^{k - 1} {σ}_{j} {δ}_{j}} ,$$

$$C ( r ) = {\sum }_{k = 1}^{m} {T}_{k} ( 1 - {e}^{- {σ}_{k} {δ}_{k}} ) {c}_{k} .$$

where, σₖ,δₖ, cₖ correspond to the variables of the k th spatial point along the light ray r through an image pixel; δₖ=tₖ₊₁−tₖ is a distance between two adjacent spatial points; tₖ is a depth of the k th spatial point, and C(r) represents the color of the light ray r in the image;
Step 8: minimizing an objective function as shown in the following formula to train N₁, N₂, N₃ and s; setting the number of network training rounds nₜ; where, after the number of training rounds is reached, the training process stops; and

$${min}_{{N}_{1} , {N}_{2} , {N}_{3} , s} Loss = {‖ {I}_{p} - C ‖}^{2} + {‖ {\vert ∇ F ( x ) \vert}^{2} - 1 ‖}^{2}$$

Step 9: outputting, using the SDF MLP network, the surface with d=0 by a matching cube algorithm; where, the output surface is the surface of solder joint.

The disclosed method represents the surface geometry of the solder joints using SDF. The method integrates the bidirectional reflectance distribution function (BRDF) to model light behaves when interacting with the surface of the solder joint, thereby determining the visual appearance of the solder joints. The method unifies SDF and BRDF within a neural radiation field rendering framework to enhance rendering efficiency and accuracy. Furthermore, the method utilizes the conventional solder joint inspection equipment to capture images of solder joints. From the images, the method reconstructs high-resolution 3D models of the solder joints at low cost.

### BRIEF DESCRIPTION OF THE DRAWINGS

FIG. 1 is the framework diagram of the reconstruction method;

FIG. 2 is the reconstruction flow chart;

FIG. 3 is the schematic diagram of image acquisition system;

FIG. 4 is the 3D reconstruction result diagram of excessive solder from three different perspectives;

FIG. 5 is the 3D reconstruction result diagram of insufficient solder from three different perspectives; and

FIG. 6 is the 3D reconstruction result diagram of normal solder from three different perspectives.

### DETAILED DESCRIPTION

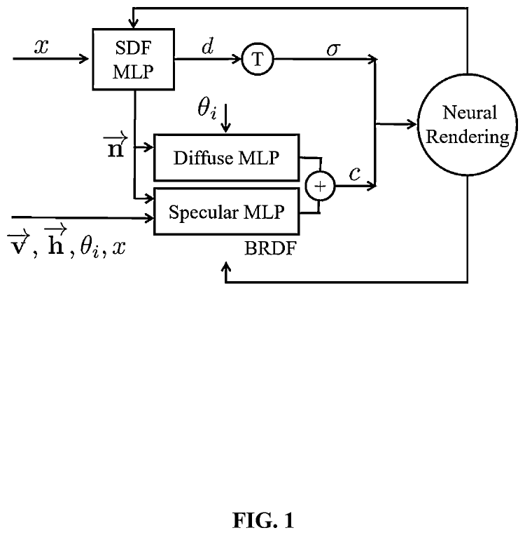

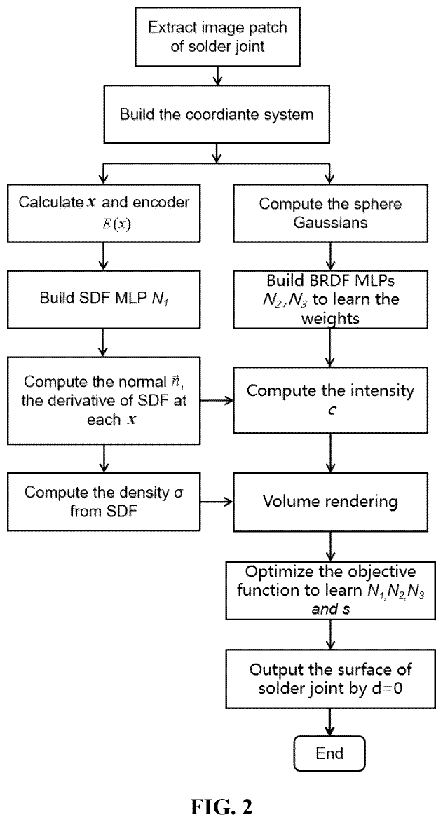

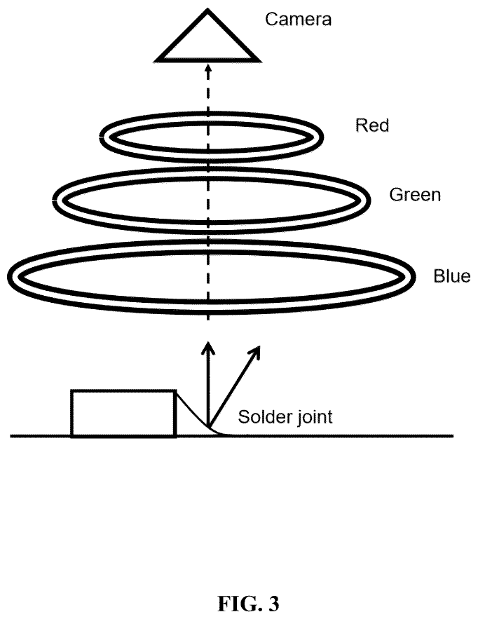

The disclosed method presents a framework illustrated in FIG. 1, with a detailed implementation process shown in FIG. 2. FIG. 3 depicts a schematic diagram of an acquisition system featuring light sources, a camera, and solder joints. The acquisition system comprises a red ring light source, a green ring light source, and a blue ring light source. The camera is disposed directly above the three ring light sources. A solder joint is positioned below the three ring light sources.
Step 1: soldering a plurality of steel balls with diameters of 1 mm, 2 mm, and 4 mm on a blank PCB; adjusting an intensity of each ring light source; collecting, using the acquisition system as shown in FIG. 3, a plurality of images of the plurality of steel balls; and calibrating an angle between z-axis and an incident light ray from each ring light source, respectively, θ^{r}=28°, θ^{g}=44°, θ^{b}=60°;
Step 2: capturing, using the acquisition system, a PCB image; extracting an image patch Iₚ corresponding to a location of a solder joint in the PCB image; where, the width of the image patch is assumed to be W and the height is H, then IₚϵR^{W×H}.
Step 3: establishing a camera coordinate system with a camera center P as an origin; and defining a viewing direction v along the negative direction of the z-axis of the camera coordinate system; sampling a light ray r passing through each pixel within the image patch along the direction of the z-axis between [−0.5,0.9]; sampling 2m (m=64) spatial points x along the light ray; diving the 2m spatial points into m uniform coarse spatial points and m fine spatial points; where, the fine spatial points is determined by leveraging the neural radiance field (NeRF) weights obtained from the coarse sampling; denoting the spatial points as \tilde{x}ϵR^{W×H×128}; transforming the spatial points \tilde{x} from the sampling space into normalized coordinates of the camera coordinate system; denoting the transformed spatial points as x;
setting a camera intrinsic matrix,

$$K = [ \begin{matrix}f & 0 & W \\ 0 & f & \frac{H}{2} \\ 0 & 0 & 1\end{matrix} ] ;$$

where f=max (W,H);
defining a matrix as follows:

$${x}_{1} = [ \begin{matrix}( 0 , 0 , 1 ) , … , ( W , 0 , 1 ) \\ … \\ ( 0 , H , 1 ) , … , ( W , H , 1 )\end{matrix} ] ,$$

$$x = {K}^{- 1} \cdot \tilde{x}$$

replacing the third dimension of x with the sampling plane distance zϵ[−0.5,0.9].
Step 4: encoding the coordinates of the transformed spatial points x as E(x)ϵR^{13×3}; and calculating E(x) as follows:

E(x)=[x, sin (x), cos (x), sin (2x), cos (2x), . . . , sin (6x), cos (6x)]
Step 5: establishing a Signed Distance Field (SDF) multi-layer perceptron (MLP) network N₁; inputting E(x) into the SDF MLP network to obtain a signed distance d from each of the plurality of spatial points to a surface of the solder joint; where, the SDF MLP network N₁ comprises a 9-layer perceptron configured in a fully connected mode; the 9-layer perceptron comprises an input layer, seven hidden layers, and an output layer; the input layer comprises 39 neurons; each hidden layer comprises 256 neurons; and the output layer comprises one neuron; a 1-dimensional vector represents the distance d; the weight of SDF MLP network N is initialized using a method that is commonly applied to MLPs designed for handling SDF;

supposing F(x) represent the SDF; and defining the opacity function as follows:

σ(x)=ϕ(F(E(x)))ϵ[0,1]

where,

$$ϕ ( F ( x ) ) = s \cdot \frac{{e}^{- s \cdot F ( x )}}{( 1 + {e}^{- s \cdot {F ( x )}^{2}} )}$$

and; an analytical partial derivative

$$\frac{\partial F ( x )}{\partial x}$$

of the SDF MLP network is calculated to obtain the normal n of the transformed spatial points x; and s is a learnable parameter;
Step 6: computing two sets of spherical Gaussians for a specular component and a diffuse component, respectively.

$${B}_{s} = [ {e}^{{λ}_{1} ( {\vec{h}}^{T} \vec{n} - 1 )} , {e}^{{λ}_{2} ( {\vec{h}}^{T} \vec{n} - 1 )} , … , {e}^{{λ}_{10} ( {\vec{h}}^{T} \vec{n} - 1 )} ] , \\ {B}_{d} = [ {e}^{{λ}_{1} ( {\vec{i}}^{T} \vec{n} - 1 )} , {e}^{{λ}_{2} ( {\vec{i}}^{T} \vec{n} - 1 )} , … , {e}^{{λ}_{10} ( {\vec{i}}^{T} \vec{n} - 1 )} ] ;$$

where Bₛ represents the spherical Gaussian basis for the specular component, B_{d} represents a spherical Gaussian basis for diffuse component, λ₁, λ₂, . . . , λ₁₀ represent preset parameters of the spherical Gaussians. \vec{h}, \vec{n}, ī represent an intermediate vector, a normal direction, and an incident light ray direction, respectively; where \vec{h}=\vec{v}+\vec{i}; and the incident light ray direction is denoted as follows:

\vec{i}=(sin θᵢ cos φᵢ, sin θᵢ sin φᵢ, cos θᵢ).

where θᵢ is an calibrated angle between the incident light ray and the viewing direction;

$${φ}_{i} = arc tan \frac{{\vec{n}}_{y}}{{\vec{n}}_{x}} ;$$

\vec{n}ₓ and \vec{n}_{y} are components of the normal \vec{n} on the x-axis and y-axis, respectively;
Step 7: constructing two BRDF MLP networks N₂ and N₃ to learn the specular component and diffuse component, respectively; where, the two BRDF MLP networks N₂ and N₃ share an identical network structure as follows: each BRDF MLP network comprises a 4-layer perceptron configured in a fully connected mode; the 4-layer perceptron comprises an input layer, two hidden layers, and an output layer; the input layer comprises three neurons; each of the two hidden layer comprises ten neurons; and the output layer comprises ten neurons, representing a 10-dimensional spherical Gaussian weight vector; the input to the sum perceptron is x, and the output of the perceptron corresponds to the weights Wₛ and W_{d} of the 10-dimensional spherical Gaussians basis,

$$c ( x ) = {W}_{d} \cdot {B}_{d} + {W}_{s} \cdot {B}_{s}$$

the components of light intensity emitted by the red ring light source, the green ring light source, and the blue ring light source at the transformed spatial points x are represented by c^{r}, c^{g}, c^{b}, respectively;
Step 8: rendering an image through σₖ, δₖ, cₖ by the rendering formula as follows:

$${T}_{k} = {e}^{- \begin{matrix}k - 1 \\ \sum \\ j = 1\end{matrix} {σ}_{j} {δ}_{j}} , \\ C ( r ) = {\sum }_{k = 1}^{m} {T}_{k} ( 1 - {e}^{- {σ}_{k} {δ}_{k}} ) {c}_{k} .$$

where, σₖ, δₖ, cₖ correspond to the variables of the k th spatial point along the light ray r, δₖ=tₖ₊₁−tₖ is the distance between two adjacent spatial points, tₖ is the depth of the k th spatial point, and C(r) represents the color of the light ray r in the image;
Step 9: minimizing an objective function as shown in the following formula to train N₁, N₂, N₃ and s; setting the number of network training rounds nₜ; where, the training process stops after 20000 rounds; and

$${min}_{{N}_{1} , {N}_{2} , {N}_{3} , s} Loss = {‖ {I}_{p} - C ‖}^{2} + {‖ {\vert ∇ F ( x ) \vert}^{2} - 1 ‖}^{2}$$

Step 10: computing the distance d of the spatial points by the SDF MLP network, and outputting the surface with |d|≤ε by the matching cube algorithm; where, the output surface is the surface of the solder joint; and ε is set to a value of 0.

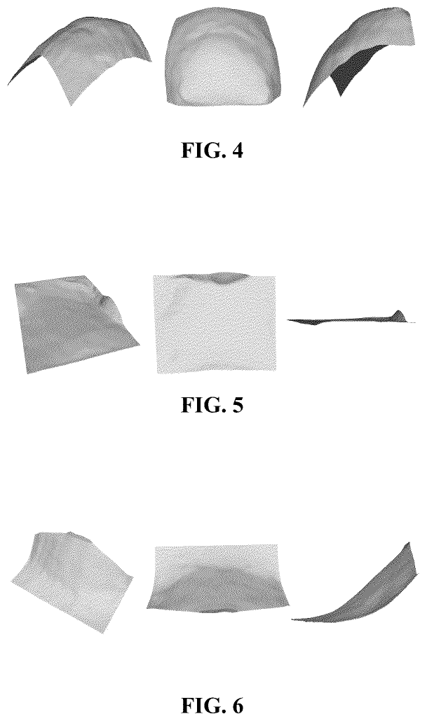

FIG. 4 shows the reconstruction result of excessive solder from three different perspectives, with a viewpoint positioned at P=(−0.5,−0.25, 1).

FIG. 5 shows the reconstruction result of insufficient solder from three different perspectives, with a viewpoint positioned at P=(0, 0, 1).

FIG. 6 shows the normal solder reconstruction result from three different perspectives, with a viewpoint positioned at P=(−0.5,−0.5, 1).

It will be obvious to those skilled in the art that changes and modifications may be made, and therefore, the aim in the appended claims is to cover all such changes and modifications.

What is claimed is:

1. A method for 3D reconstruction of a solder joint on a printed circuit board (PCB) utilizing neural rendering, the method comprising:
1) soldering a plurality of steel balls of different known diameters onto a blank PCB; providing an acquisition system comprising a red ring light source, a green ring light source, and a blue ring light source; collecting, using the acquisition system, a plurality of images of the plurality of steel balls;
2) establishing a camera coordinate system with a camera center P as an origin; and defining a viewing direction \vec{v} along the negative direction of the z-axis of the camera coordinate system;
3) calibrating an angle θ=[θ^{r}, θ^{g}, θ^{h}] between an incident light ray from each ring light source and the viewing direction; and performing multiple calibrations using the plurality of steel balls of different known diameters to determine an average angle;
4) capturing, using the acquisition system, a PCB image; extracting an image patch Iₚ corresponding to a location of a solder joint in the PCB image;
wherein a width of the image patch is assumed to be W and a height of the image patch is H;
5) sampling a light ray passing through each pixel in the image patch along the direction of the z-axis; sampling a plurality of spatial points \tilde{x} along a light ray passing through the camera center P; transforming the spatial points \tilde{x} into a normalized coordinates system; denoting the plurality of transformed spatial points as x; and encoding the coordinates of the plurality of transformed spatial points x as E(x); wherein the coordinates of the plurality of spatial points are denoted by \tilde{x}ΣR^{W×H×m}, and the number of the plurality of spatial points is m; and E(x) is calculated as follows:
E(x)=[x,sin (x),cos (x),sin (2x), cos (2x), . . . ,sin (6x), cos (6x)];
6) establishing a Signed Distance Field (SDF) Multi-Layer Perceptron (MLP) network N₁; inputting E(x) into the MLP network to obtain a signed distance d from each of the plurality of spatial points to a surface of the solder joint; supposing F(x) represent the SDF, and defining an opacity function as follows:
σ(x)=ϕ(F(E(x)))ϵ[0,1];
where,
$$ϕ ( F ( x ) ) = s \cdot \frac{{e}^{- s \cdot F ( x )}}{( 1 + {e}^{- s \cdot {F ( x )}^{2}} )}$$
and; an analytical partial derivative
$$\frac{\partial F ( x )}{\partial x}$$
of the SDF MLP network is calculated to obtain the normal \vec{n} of the plurality of transformed spatial points x; and s is a learnable parameter;
7) computing two sets of spherical Gaussians for a specular component and a diffuse component, respectively;
$${B}_{s} = [ {e}^{{λ}_{1} ( {\vec{h}}^{T} \vec{n} - 1 )} , {e}^{{λ}_{2} ( {\vec{h}}^{T} \vec{n} - 1 )} , … , {e}^{{λ}_{10} ( {\vec{h}}^{T} \vec{n} - 1 )} ] ; \\ {B}_{d} = [ {e}^{{λ}_{1} ( {\vec{i}}^{T} \vec{n} - 1 )} , {e}^{{λ}_{2} ( {\vec{i}}^{T} \vec{n} - 1 )} , … , {e}^{{λ}_{10} ( {\vec{i}}^{T} \vec{n} - 1 )} ] ;$$
where Bₛ represents a spherical Gaussian basis for the specular component, B_{d} represents a spherical Gaussian basis for the diffuse component, λ₁, λ₂, . . . , λ₁₀ represent preset parameters of the spherical Gaussians basis; \vec{h},\vec{n},ī represent an intermediate vector, a normal direction, and an incident light ray direction, respectively; where \vec{h}=\vec{v}+\vec{i}; and the incident light ray direction is denoted as follows:
\vec{i}=(sin θᵢ cos φᵢ, sin θᵢ sin φᵢ, cos θᵢ)
where θᵢ is a calibrated angle between the incident light ray and the viewing direction;
$${φ}_{i} = arc tan \frac{{\vec{n}}_{y}}{{\vec{n}}_{x}} ,$$
\vec{n}ₓ and \vec{n}_{y} are components of the normal \vec{n} on the x-axis and y-axis, respectively; a mixed reflection model of light intensity is given by
$$c = {W}_{d} \cdot {B}_{d} + {W}_{s} \cdot {B}_{s} ;$$
8) constructing two Bidirectional Reflectance Distribution Function (BRDF) Multi-Layer Perceptron (MLP) networks N₂ and N₃ with identical network structure; inputting x into both the two MLP networks N₂ and N₃; generating an output from each MLP network; wherein the output from MLP network N₂ is a weight W_{d} corresponding to a 10-dimensional spherical Gaussians, and the output from MLP network N₃ is a weight Wₛ corresponding to a 10-dimensional spherical Gaussians; the components of intensity of light emitted by the red ring light source, the green ring light source, and the blue ring light source at the transformed sampled spatial points x are represented by c^{r}, c^{g}, c^{b};
$$c ( x ) = {W}_{d} \cdot {B}_{d} + {W}_{s} \cdot {B}_{s} ;$$
9) rendering an image C through σₖ, δₖ, cₖ by the rendering formula:
$${T}_{k} = {e}^{- \begin{matrix}k - 1 \\ \sum \\ j = 1\end{matrix} {σ}_{j} {δ}_{j}} , \\ C ( r ) = {\sum }_{k = 1}^{m} {T}_{k} ( 1 - {e}^{- {σ}_{k} {δ}_{k}} ) {c}_{k} .$$
where, σₖ, δₖ, cₖ correspond to the variables of the k th spatial point along a light ray r through an image pixel; δₖ=tₖ₊₁−tₖ is a distance between two adjacent spatial points; tₖ is a depth of the k th spatial point; and C(r) represents the color of the light ray r in the image;
10) minimizing an objective function as shown in the following formula to train N₁, N₂, N₃ and s; setting a number of network training rounds n₁; wherein after the number of training rounds is reached, the training process stops; and
$${min}_{{N}_{1} , {N}_{2} , {N}_{3} , s} Loss = {‖ {I}_{p} - C ‖}^{2} + {‖ {\vert ∇ F ( x ) \vert}^{2} - 1 ‖}^{2}$$
11) computing a distance d of the plurality of spatial points by the SDF MLP network, and outputting a surface with |d|≤ε by a matching cube algorithm; wherein, the output surface is the surface of the solder joint; and ε is set to a value of 0.

2. The method of claim 1, wherein the SDF MLP network N₁ comprises a 9-layer perceptron configured in a fully connected mode; the 9-layer perceptron comprises an input layer, seven hidden layers, and an output layer; the input layer comprises three neurons; each hidden layer comprises 256 neurons; and the output layer comprises one neuron.

3. The method of claim 1, wherein the BRDF MLP network N₂ comprises a 4-layer perceptron configured in a fully connected mode; the 4-layer perceptron comprises an input layer, two hidden layers, and an output layer; the input layer comprises three neurons; each hidden layer comprises ten neurons; and the output layer comprises ten neurons.
